(19) United States
(12) Patent Application Publication
(10) Pub. No.: US 2004/0118144 A1
(43) Pub. Date: Jun. 24, 2004

(54) Hermetic inverter/converter chamber with multiple pressure and cooling zones

(76) Inventors: John S. Hsu, Oak Ridge, TN (US); Donald J. Adams, Knoxville, TN (US); Gui-Jia Su, Knoxville, TN (US); Laura D. Marlino, Oak Ridge, TN (US); Curtis W. Ayers, Kingston, TN (US); Chester Coomer, Knoxville, TN (US)

Correspondence Address: Kirk A. Wilson, UT-Battelle, LLC, MS 6498, P O Box 2008, Oak Ridge, TN, 37831, US

(21) Appl. No.: 10/716,060

(22) Filed: Nov. 18, 2003

Related U.S. Application Data
(60) Provisional application No. 60/435,157, filed on Dec. 20, 2002.

(51) Int. Cl. F25D 23/12; H01G 9/02

(52) U.S. Cl. 62/259.2; 361/505

(57) ABSTRACT

A multiple zone hermetic inverter/converter chamber for cooling power electronics using direct contact cooling in the liquid refrigerant zone and vapor refrigerant zone located in the hermetic container, and indirect non-contact cooling in the ambient cooling zone located in the interstitial space between the hermetic container and the thermally isolated housing. The ambient cooling zone operates at atmospheric pressure.

### CROSS-REFERENCE TO RELATED APPLICATIONS

This application claims priority to U.S. Provisional Patent Application 60/435,157, filed Dec. 20, 2002, herein incorporated by reference.

### STATEMENT REGARDING FEDERAL SPONSORSHIP

This invention was made with Government support under contract no. DE-AC05-00OR22725 to UT-Battelle, LLC, awarded by the United States Department of Energy. The Government has certain rights in the invention.

### TECHNICAL FIELD

The field of the invention is methods and apparatus for cooling of electrical devices and electronic components in power electronics bays of high capacity systems such as an electric vehicle.

### DESCRIPTION OF THE BACKGROUND ART

Electric vehicles typically utilize an inverter in the form of a switch-mode power supply to provide three phase operating power to the vehicle's electric drive motor. The inverter includes a number of power switching devices that can supply the high currents needed. The inverter is usually located in an environmentally sealed module that is commonly referred to as the power electronics bay (PEB). This module typically includes other electronic circuits, such as those used to run the vehicle's electronic power steering, climate control compressor motor, and traction control system.

To effectively remove the heat radiated from the inverter and other circuitry within the power electronics bay, the circuits themselves are enclosed together within a grounded metal chassis that has a means for cooling the components. This chassis normally includes a housing having feedthrough electrical terminal assemblies (for power, control, and data signals) as well as inlet and outlet coolant manifold that permit liquid coolant to be circulated through the power electronics bay for cooling of the inverter's power switching devices. In a typical liquid-cooled inverter application, the power switching devices are mounted in a single cooling zone by their baseplates to a conductive metallic liquid-interface heat exchanger wherein indirect, non-contact cooling of the power electronics devices is performed. Every power electronics device is exposed to a single coolant temperature and pressure without consideration of device specific environmental constraints. Also, using indirect non-contact cooling via heat exchangers has low efficiency due to conductive and convective heat transfer resistances imposed by the heat exchanger materials and surfaces.

Accordingly, there exists a need for a power electronics multi-zone cooling chamber having direct contact and indirect contact cooling that maintains good thermal conduction from the power switching devices while reducing the radiated EMI due to currents flowing from the switching devices and into the chassis.

### SUMMARY OF THE INVENTION

The invention provides a multiple zone hermetic inverter/converter chamber for cooling power electronics using direct contact cooling in the liquid refrigerant zone and vapor refrigerant zone located in the hermetic container, and indirect non-contact cooling in the ambient cooling zone located in the interstitial space between the hermetic container and the thermally isolated housing. The ambient cooling zone operates at atmospheric pressure.

The invention provides a hermetic inverter/converter chamber that uses direct contact between the refrigerant and high capacity power electronics for high efficiency heat transfer.

The invention provides a hermetic inverter/converter chamber for hybrid electric vehicles.

The invention provides hermetic inverter/converter chamber for full electric vehicles.

The invention provides a hermetic inverter/converter chamber that accumulates liquid refrigerant of a vapor compression refrigeration system and cools mounted power electronic components submerged in the liquid refrigerant zone and the vapor refrigerant zone.

The invention provides a hermetic inverter/converter chamber with an indirect non-contact ambient pressure cooling zone operating at atmospheric pressure.

The invention provides a hermetic inverter/converter chamber for cooling inverters and other electronic modules in the power electronics bay.

The invention provides a hermetic inverter/converter chamber for electromagnetic interference (EMI) shielding.

The invention provides a hermetic inverter/converter chamber as an integral part of the air conditioning system of a vehicle.

The invention provides an intermediate pressure suction tapping point on the compressor for an intermediate pressure/temperature refrigeration circuit to the chamber.

The refrigerant can be any phase change working fluid, as defined in ASHRAE Standard 34-2001, that transfers heat; such as halogenated compounds (CFC's) of the methane, ethane, and propane series, cyclic organic compounds, zeotropes, azeotropes, nitrogen compounds, inorganic compounds and elements such as water, and unsaturated organic compounds.

### BRIEF DESCRIPTION OF THE DRAWINGS

FIG. 1 is a preferred embodiment of the hermetic inverter/converter cooling chamber with multiple pressure and cooling zones.

FIG. 2 is an embodiment with an extended outlet coil.

FIG. 3 is an embodiment with extended solid or refrigerant-filled cooling fins from hermetic container.

FIG. 4 is an embodiment of the cooling chamber disposed in a compressor suction line of a typical vapor compression cooling system.

FIG. 5 is an embodiment of the cooling chamber disposed as a intermediate-temperature evaporator using intermediate-pressure compressor suction tapping for cooling a branch at an intermediate pressure and temperature for energy savings.

FIG. 6 is a typical two stage screw compressor showing an intermediate suction inlet tap point.

### DETAILED DESCRIPTION

The components in a power electronic inverter and/or converter possess design constraints that must be considered for proper operation. For instance, the power electronic dies, such as those of the IGBT or MOSFET, have little thermal capacity with a critical junction temperature and can be located in a high pressure refrigerant zone, either liquid or vapor, thereby using direct refrigerant contact cooling. The electrolytic capacitors have better thermal capacity than the dies, but should not be placed in a high pressure cooling zone because unwanted material will sip into the electrolyte material between the positive and negative foils. The capacitors can be located in the ambient cooling zone where indirect cooling at atmospheric pressure is provided by heat transfer to the refrigerant through the hermetic container.

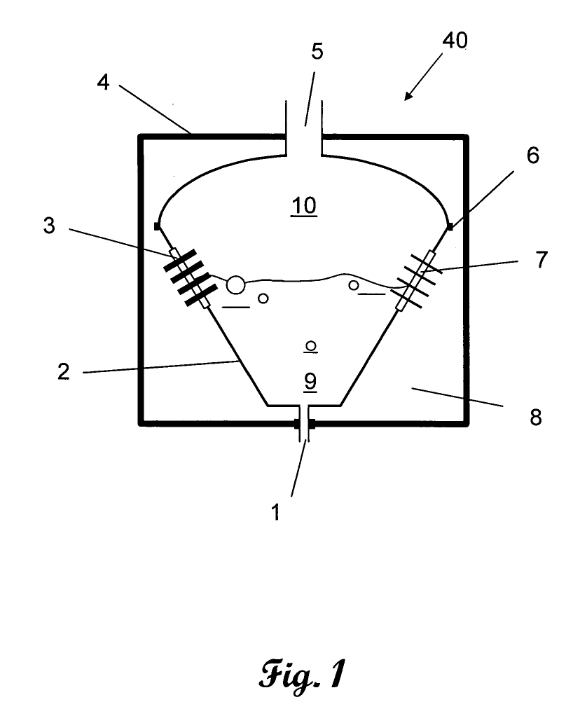

FIG. 1 shows a preferred arrangement of the multi-zone hermetic inverter/converter cooling chamber 40. The hermetic container 2 can be made of steel, magnetic material, non-magnetic material, metal, and non-metal pressure vessel materials that meet the pressure, temperature and sealing requirements of the refrigerant and the EMI shielding requirements of the electronic components. At least one sealed power connector 3, at least one sealed signal connector 7, and a joint seam 6 is integral with the walls of the hermetic container 2. The hermetic container 2 has at least one liquid refrigerant inlet 1 and at least one vapor refrigerant outlet 5. There are two zones inside the hermetic container 2; one is the liquid refrigerant zone 9 and the other is the vapor refrigerant zone 10. The liquid refrigerant zone 9 is suitable for cooling the power electronic dies and other critical components using direct liquid refrigerant contact cooling. The vapor refrigerant zone 10 is suitable for cooling the less critical, high thermal capacity components using direct vapor refrigerant contact cooling. The ambient cooling zone 8, outside the hermetic container 2, provides cooled ambient pressure conditions for cooling components such as the electrolytic capacitors at atmospheric pressure. A thermally isolated housing 4 isolates the ambient cooling zone 8 from the ambient and creates a cooled interstitial space between the refrigerant filled hermetic container 2 and the thermally isolated housing 4. The interstitial space is the ambient cooling zone 8 that is cooled by indirect heat transfer to the refrigerant through the refrigerant filled hermetic container 2. The hermetic container 2 and the thermally isolated housing 4 with metal mesh (or foil) can be used for EMI shielding.

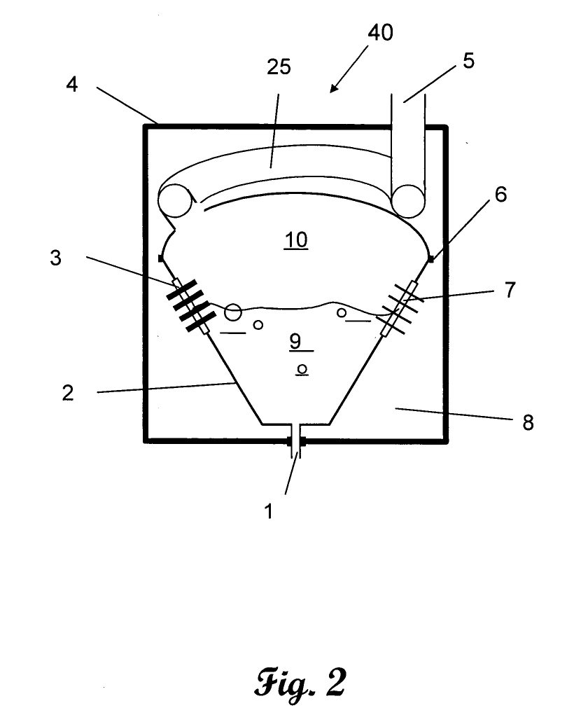

FIG. 2 is an embodiment of the multi-zone hermetic inverter/converter cooling chamber 40 having an extended outlet coil 25 to provide additional cooling in the ambient cooling zone 8.

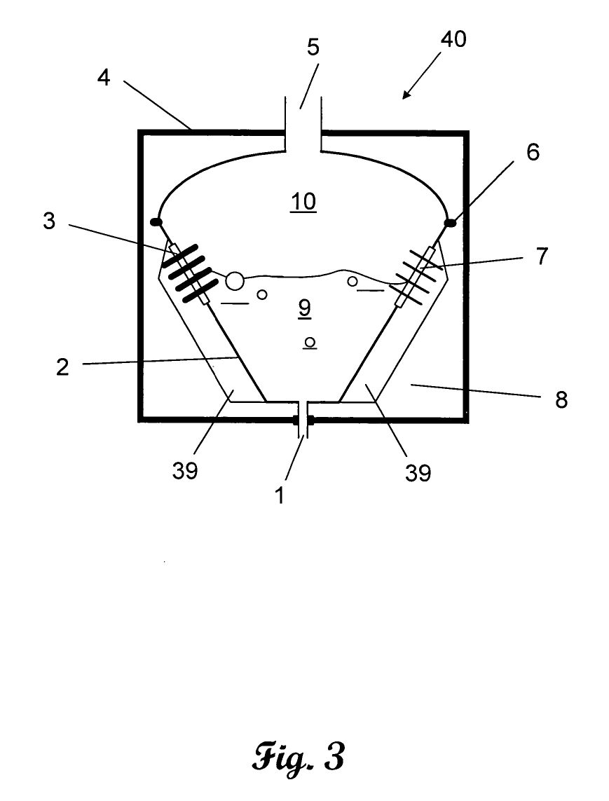

FIG. 3 is an embodiment of the multi-zone hermetic inverter/converter cooling chamber 40 having the hermetic container 2 formed with additional solid or refrigerant-filled cooling fins 39 to cool the ambient cooling zone 8. The cooling fins 39 can also be used as heat sinks for direct mounting of inverter/converter components.

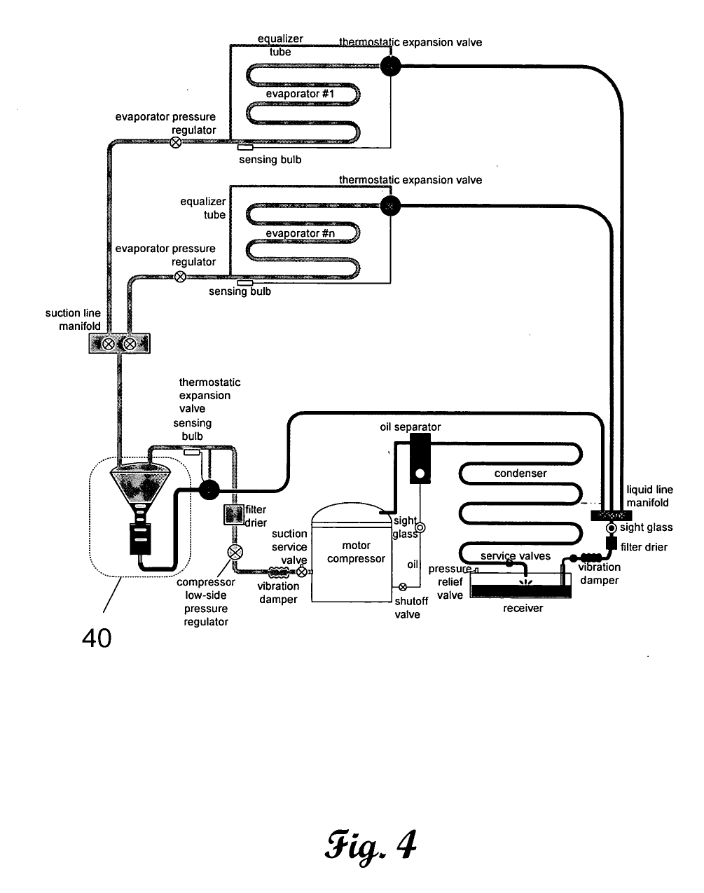

FIG. 4 shows an embodiment of the inverter/converter cooling chamber 40 as one of the components of a vapor compression refrigeration system.

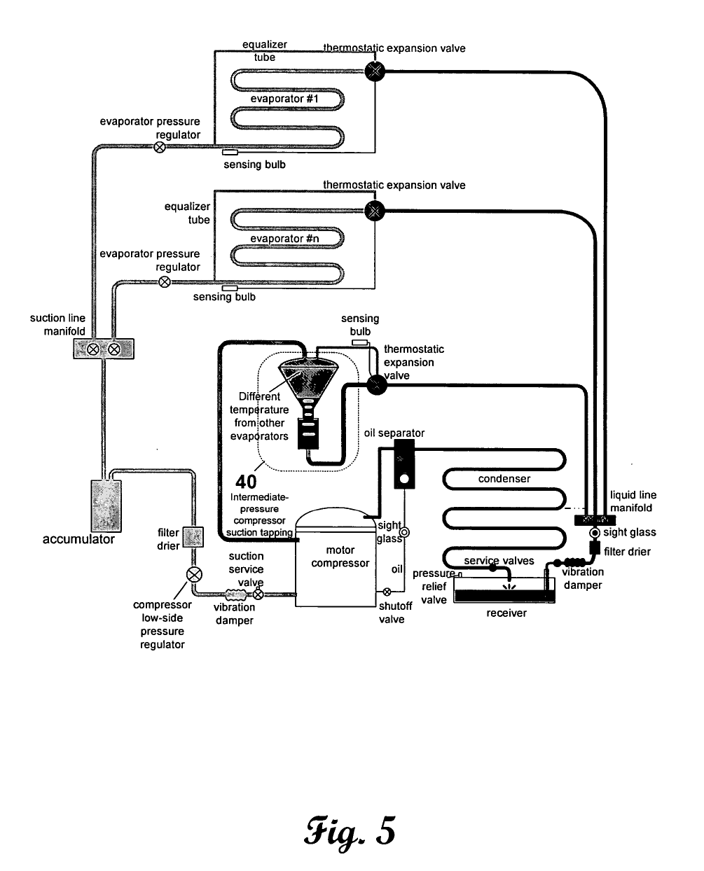

FIG. 5 shows an embodiment of the inverter/converter cooling chamber 40 connected to an intermediate-pressure compressor suction tapping line for energy savings and disposed as an intermediate circuit component of a vapor compression refrigeration system.

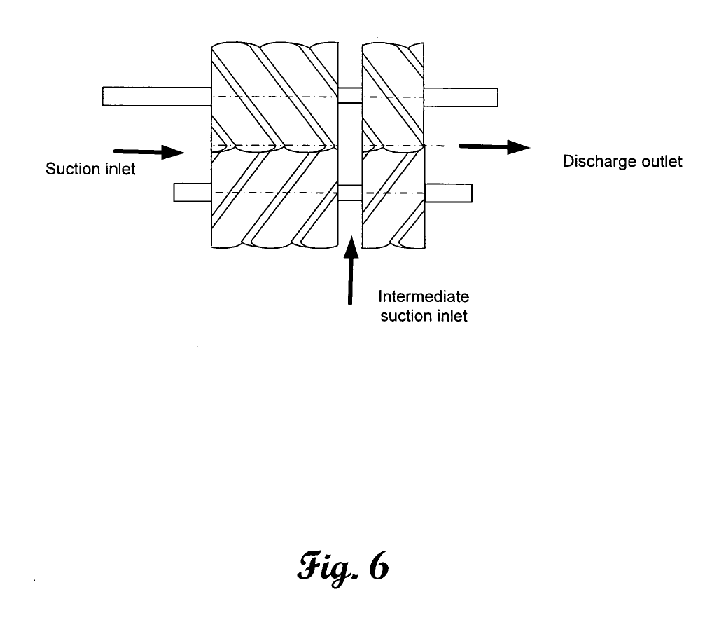

FIG. 6 shows a two-stage screw compressor with an intermediate suction tapping point for supplying the intermediate refrigeration circuit of FIG. 5. The tapping point can be applied to any type compressor including reciprocating, rotary, screw, orbital, scroll, trochoidal, and centrifugal compressors.

Inverter/converter components are cooled by mounting at least a portion of the inverter/converter components in the ambient cooling zone 8 for indirect non-contact cooling, mounting at least a portion of the inverter/converter components in the liquid refrigerant zone 9 for direct liquid refrigerant contact cooling, mounting at least a portion of the inverter/converter components in the vapor refrigerant zone 10 for direct vapor refrigerant contact cooling, and flowing a refrigerant through the hermetic container 2 to remove heat dissipated by the inverter/converter components. The refrigerant inlet 1 tube to the inverter/converter cooling chamber 40 can also be used for blowing off the boiling bubbles on the components being cooled.

While there has been shown and described what are at present considered the preferred embodiments of the invention, it will be obvious to those skilled in the art that various changes and modifications can be made therein without departing from the scope.

We claim:

1. An inverter/converter cooling chamber comprising,
a thermally isolated housing,
a hermetic container at least partially disposed in said thermally isolated housing,
an ambient cooling zone disposed interstitially between said hermetic container and said thermally isolated housing for indirect non-contact cooling of inverter/converter components,
a liquid refrigerant zone at least partially disposed in said hermetic container for direct liquid refrigerant contact cooling of inverter/converter components,
a vapor refrigerant zone at least partially disposed in said hermetic container adjacent said liquid refrigerant zone for direct vapor refrigerant contact cooling of inverter/converter components.

2. The cooling chamber of claim 1 wherein said hermetic container is a pressure vessel material selected from the group consisting of steel, magnetic material, non-magnetic material, metals, and non-metals.

3. The cooling chamber of claim 1 wherein said hermetic container further comprises a liquid refrigerant inlet and a vapor refrigerant outlet.

4. The cooling chamber of claim 3 wherein said vapor refrigerant outlet further comprises an extended outlet coil at least partially disposed in said ambient cooling zone.

5. The cooling chamber of claim 1 wherein said hermetic container further comprises a sealed power connector and a sealed signal connector.

6. The cooling chamber of claim 1 wherein said hermetic container further comprises at least one cooling fin.

7. The cooling chamber of claim 6 wherein said cooling fins are refrigerant filled.

8. The cooling chamber of claim 6 wherein said cooling fins are solid material.

9. The cooling chamber of claim 1 wherein said hermetic container and thermally isolated housing further comprise EMI shielding selected from the group consisting of metal mesh and foil.

10. The cooling chamber of claim 1 wherein said chamber cools power electronic components of vehicles selected from the group consisting of hybrid and full electric.

11. The cooling chamber of claim 1 wherein said chamber is disposed as a liquid refrigerant accumulator component of a vapor compression refrigeration system.

12. The cooling chamber of claim 1 wherein said refrigerant is selected from the group consisting of the phase change working fluids listed in ASHRAE Standard 34-2001.

13. The cooling chamber of claim 1 wherein said chamber is disposed as an intermediate-temperature evaporator component of a vapor compression refrigeration system.

14. The cooling chamber of claim 13 wherein said chamber is disposed in an intermediate pressure suction tapping line.

15. A method of cooling inverter/converter components comprising the steps of,
providing a thermally isolated housing,
providing a hermetic container at least partially disposed in said thermally isolated housing,
mounting at least a portion of said inverter/converter components in an ambient cooling zone disposed interstitially between said hermetic container and said thermally isolated housing for indirect non-contact cooling,
mounting at least a portion of said inverter/converter components in a liquid refrigerant zone at least partially disposed in said hermetic container for direct liquid refrigerant contact cooling,
mounting at least a portion of said inverter/converter components in a vapor refrigerant zone at least partially disposed in said hermetic container adjacent said liquid refrigerant zone for direct vapor refrigerant contact cooling,
flowing a refrigerant through said hermetic container to remove heat dissipated by said inverter/converter components.

16. The method of claim 15 wherein said hermetic container is a pressure vessel material selected from the group consisting of steel, magnetic material, non-magnetic material, metals, and non-metals.

17. The method of claim 15 wherein said hermetic container further comprises a liquid refrigerant inlet and a vapor refrigerant outlet.

18. The method of claim 17 wherein said vapor refrigerant outlet further comprises an extended outlet coil at least partially disposed in said ambient cooling zone.

19. The method of claim 15 wherein said hermetic container further comprises a sealed power connector and a sealed signal connector.

20. The method of claim 15 wherein said hermetic container further comprises at least one cooling fin.

21. The method of claim 20 wherein said cooling fins are refrigerant filled.

22. The method of claim 20 wherein said cooling fins are solid material.

23. The method of claim 15 wherein said hermetic container and thermally isolated housing further comprise EMI shielding selected from the group consisting of metal mesh and foil.

24. The method of claim 15 wherein said chamber cools power electronic components of vehicles selected from the group consisting of hybrid and full electric.

25. The method of claim 15 wherein said chamber is the liquid refrigerant accumulator component of a vapor compression refrigeration system.

26. The method of claim 15 wherein said refrigerant is selected from the group consisting of the phase change working fluids listed in ASHRAE Standard 34-2001.

27. The method of claim 15 wherein said chamber is disposed as an intermediate-temperature evaporator component of a vapor compression refrigeration system.

28. The method of claim 27 wherein said chamber is disposed in an intermediate pressure suction tapping line.
